(19) United States
(12) Patent Application Publication
(10) Pub. No.: US 2026/0307672 A1
(43) Pub. Date: Oct. 8, 2026

(54) METHOD AND SYSTEM FOR NOTIFYING START OF TARGET VEHICLE

(71) Applicant: HL KLEMOVE CORP., Incheon (KR)

(72) Inventors: Joeun LEE, Incheon (KR); Eunsan JO, Incheon (KR)

(21) Appl. No.: 19/286,594

(22) Filed: Jul. 31, 2025

(30) Foreign Application Priority Data
Apr. 3, 2025 (KR) 10-2025-0043198

(51) Int. Cl. B60W 50/14; G06V 20/56

(52) U.S. Cl. CPC B60W 50/14; G06V 20/588; B60W 2552/05; B60W 2554/4041; B60W 2554/4042

(57) ABSTRACT

A method for notifying start of a target vehicle according to an embodiment of the present disclosure comprises: collecting road information and lane information of a driving road of an ego vehicle; determining a type of the driving road of the ego vehicle and a position of the ego vehicle; determining a target vehicle among surrounding vehicles, based on the type of the driving road of the ego vehicle; determining whether the target vehicle has started; and notifying start of the target vehicle to a driver of the ego vehicle in response to determining that the target vehicle has started.

### CROSS-REFERENCE TO RELATED APPLICATION

This application claims the benefit of and priority to Korean Patent Application No. 10-2025-0043198 filed on Apr. 3, 2025, the entire disclosures of which are incorporated herein by reference.

### TECHNICAL FIELD

The present disclosure relates to a method and system for notifying start of a target vehicle. More specifically, the present disclosure relates to a method and system for notifying start of a target vehicle, by providing a start notification to a driver of an ego vehicle by making the target vehicle determination different based on whether the type of a driving road of the ego vehicle is an intersection.

### BACKGROUND

In a vehicle, a Driver Assistance System provides support to a driver while driving in the vehicle for the driver's convenience.

For example, as traffic congestion increases, the traffic congestion sections are increasing, and accordingly, cases where drivers cannot immediately prepare for the start of a front vehicle have increased, and thus, a front vehicle start notification system that informs the driver of the front vehicle's start has been disseminated.

Meanwhile, in a case where a start notification is collectively performed for the driver of the ego vehicle considering only the start state of the front vehicle, there is a concern that inconvenience may be caused to a rear vehicle because notification is not provided when the ego vehicle is waiting for a traffic signal as a leading vehicle.

In addition, using traffic signal recognition or V2X communication requires additional hardware and also has the problem of being expensive.

Therefore, in performing a start notification to the driver of the ego vehicle, there is a demand for a method and system for start notification that estimates a traffic signal based on analysis of a road shape (type) or movement of surrounding vehicles (target vehicles) and performs start notification.

### SUMMARY

The present disclosure is to solve the problems of the prior art described above, and an object of the present disclosure is to provide a method and system for notifying start of a target vehicle that estimates traffic signal change by analyzing the type of the road and the movement of surrounding vehicles and performs start notification to the driver.

However, the technical problems to be achieved by the embodiments of the present disclosure are not limited to the technical problems described above, and other technical problems may exist.

As a technical means for achieving the above technical problem, a method of notifying start of a target vehicle according to an embodiment of the present disclosure comprises: collecting road information and lane information of a driving road of an ego vehicle; determining a type of the driving road of the ego vehicle and a position of the ego vehicle; determining a target vehicle among surrounding vehicles, based on the type of the driving road of the ego vehicle; determining whether the target vehicle has started; and notifying start of the target vehicle to a driver of the ego vehicle in response to determining that the target vehicle has started.

Further, the collecting of the road information and the lane information may comprise collecting information from at least one of a front camera or a Standard Definition (SD) Map on the ego vehicle.

Further, in the determining of the target vehicle, in response to determining that the driving road of the ego vehicle is an intersection, a surrounding vehicle in an adjacent lane of a driving lane of the ego vehicle may be determined as the target vehicle.

Further, in the determining of the target vehicle, in response to determining that the driving road of the ego vehicle is an intersection, and the ego vehicle is a leading vehicle stopped right before entering the intersection, a surrounding vehicle in an adjacent lane of a driving lane of the ego vehicle may be determined as the target vehicle.

Further, in the determining of the target vehicle, in response to determining that the driving road of the ego vehicle is an intersection, a driving lane of the ego vehicle is a straight lane, and an adjacent lane of the driving lane of the ego vehicle is a left-turn lane or a right-turn lane, a surrounding vehicle in the adjacent lane may be excluded from being determined as the target vehicle.

Further, in the determining of the target vehicle, in response to determining that the driving road of the ego vehicle is an intersection, a driving lane of the ego vehicle is a left-turn lane or a right-turn lane, and an adjacent lane of the driving lane of the ego vehicle is a straight lane, a surrounding vehicle in the adjacent lane may be excluded from being determined as the target vehicle.

Further, in the determining of the target vehicle, in response to determining that the driving road of the ego vehicle is not an intersection, at least one vehicle of (i) an oncoming surrounding vehicle or (ii) a surrounding vehicle in an adjacent lane of a driving lane of the ego vehicle may be determined as the target vehicle.

Further, in the determining of the target vehicle, in response to determining that the driving road of the ego vehicle is not an intersection, and the ego vehicle may be a leading vehicle stopped right before a crosswalk, at least one vehicle of (i) an oncoming surrounding vehicle or (ii) a surrounding vehicle in an adjacent lane of a driving lane of the ego vehicle may be determined as the target vehicle.

Further, the method may further comprise : in response to determining that the oncoming surrounding vehicle is the target vehicle, and the target vehicle has started, estimating that a traffic signal of the ego vehicle is a straight driving signal.

Further, the notifying of the start of the target vehicle may comprise providing at least one of a visual notification or an audible notification to the driver of the ego vehicle.

A system for notifying start of a target vehicle according to embodiments of the present disclosure comprises: a sensor configured to provide road information and lane information of a driving road of an ego vehicle; and a controller comprising at least one processor configured to determine a type of the driving road of the ego vehicle and a position of the ego vehicle based on information from the sensor, and control the ego vehicle, wherein the controller is further configured to determine a target vehicle among surrounding vehicles based on the type of the driving road of the ego vehicle, determine whether the target vehicle has started, and notify start of the target vehicle to a driver of the ego vehicle in response to determining the target vehicle has started.

Further, the sensor may comprise at least one of a front camera or a Standard Definition (SD) Map on the ego vehicle.

Further, the sensor may further comprise a Global Positioning System (GPS) sensor.

Further, in response to determining that the driving road of the ego vehicle is an intersection, the controller may be configured to determine a surrounding vehicle in an adjacent lane of a driving lane of the ego vehicle as the target vehicle.

Further, in response to determining that the driving road of the ego vehicle is an intersection, a driving lane of the ego vehicle is a straight lane, and an adjacent lane of the driving lane of the ego vehicle is a left-turn lane or a right-turn lane, the controller may be configured to exclude a surrounding vehicle in the adjacent lane from being determined as the target vehicle.

Further, in response to determining that the driving road of the ego vehicle is an intersection, a driving lane of the ego vehicle is a left-turn lane or a right-turn lane, and an adjacent lane of the driving lane of the ego vehicle is a straight lane, the controller may be configured to exclude a surrounding vehicle in the adjacent lane from being determined as the target vehicle.

Further, in response to determining that the driving road of the ego vehicle is not an intersection, the controller may be configured to determine at least one of (i) an oncoming surrounding vehicle or (ii) a surrounding vehicle in an adjacent lane of a driving lane of the ego vehicle as the target vehicle.

Further, in response to determining that the oncoming surrounding vehicle is the target vehicle, and the target vehicle has started, the controller may be configured to estimate that a traffic signal of the ego vehicle is a straight driving signal.

Further, the system may further comprise: a notification apparatus configured to notify the start of the target vehicle to the driver of the ego vehicle, wherein the controller may be connected to the notification apparatus and configured to control the notification apparatus to provide at least one of a visual notification or an audible notification to the driver of the ego vehicle in response to determining that the target vehicle has started.

Meanwhile, in a non-transitory computer-readable recording medium that records therein a program executable by a computer to cause the computer to execute a method of notifying start of a target vehicle according to an embodiment of the present disclosure, the method comprises: collecting road information and lane information of a driving road of an ego vehicle; determining a type of the driving road of the ego vehicle and a position of the ego vehicle; determining a target vehicle among surrounding vehicles, based on the type of the driving road of the ego vehicle; determining whether the target vehicle has started; and notifying start of the target vehicle to a driver of the ego vehicle in response to determining that the target vehicle has started.

The above-described means for solving the problem is only exemplary and should not be construed as limiting the present disclosure. In addition to the exemplary embodiments described above, additional embodiments may exist in the drawings and the following detailed description.

According to the problem-solving means of the present disclosure described above, by performing start notification to the driver of the ego vehicle based on the type of the driving road of the ego vehicle and the movement of surrounding vehicles, it is possible to provide a method and system for notifying start of a target vehicle that can enable the ego vehicle to start quickly, thereby improving driver convenience, resolving inconvenience of rear vehicles, and alleviating traffic congestion.

Further, according to the means for solving the problems of the present disclosure, by making the target vehicle determination method different when the driving road of the ego vehicle is an intersection and when the driving road is not an intersection, it is possible to provide a method and system for notifying start of a target vehicle that can effectively determine the target vehicle which is the basis for start notification.

However, the effects obtainable from the present disclosure are not limited to the effects described above, and other effects may exist.

### BRIEF DESCRIPTION OF THE DRAWINGS

FIG. 1 is a control flowchart showing a method for notifying start of a target vehicle according to an embodiment of the present disclosure.

FIG. 2 is a control flowchart more specifically showing a step of determining a target vehicle in the method for notifying start of the target vehicle according to the embodiment of the present disclosure.

FIG. 3 is a diagram showing a driving scenario for explaining a method of determining a target vehicle among surrounding vehicles if the type of the driving road of the ego vehicle is an intersection, in the method for notifying start of the target vehicle according to the embodiment of the present disclosure.

FIG. 4 is a diagram showing a driving scenario for explaining a case of excluding surrounding vehicles from the target vehicle if the type of the driving road of the ego vehicle is an intersection, in the method for notifying start of the target vehicle according to the embodiment of the present disclosure.

FIG. 5 is a diagram showing a driving scenario for explaining a method of determining a target vehicle among surrounding vehicles if the type of the driving road of the ego vehicle is not an intersection, in the method for notifying start of the target vehicle according to the embodiment of the present disclosure.

FIG. 6 is a control configuration diagram schematically showing the configuration of a system for notifying start of a target vehicle according to embodiments of the present disclosure.

### DETAILED DESCRIPTION

Hereinafter, with reference to the accompanying drawings, embodiments of the present disclosure will be described in detail so that those skilled in the art can easily practice the embodiments. However, the present disclosure may be implemented in many different forms and is not limited to the embodiments described herein. In addition, in order to clearly describe the present disclosure in the drawings, parts irrelevant to the description are omitted, and similar reference numerals are attached to similar parts throughout the present disclosure.

Throughout the present disclosure, if a part is said to be “connected” to another part, it is not only “directly connected”, but also “electrically connected” with another element in between, including cases where they are “indirectly connected”.

Throughout the present disclosure, if one member is said to be located “on”, “above”, “under”, or “below” the other member, this includes not only the case of being in contact with the other member, but also the case that another member is positioned between the two members.

Throughout the present disclosure, if a part "includes" a certain component, it does not mean excluding other components, and it does mean that it may further include other components, unless otherwise stated.

Various embodiments of the present disclosure generally relate to a method and system for notifying start of a target vehicle, which provides a start notification to a driver of an ego vehicle by determining the target vehicle in different ways according to the type (shape) of the driving road of the ego vehicle.

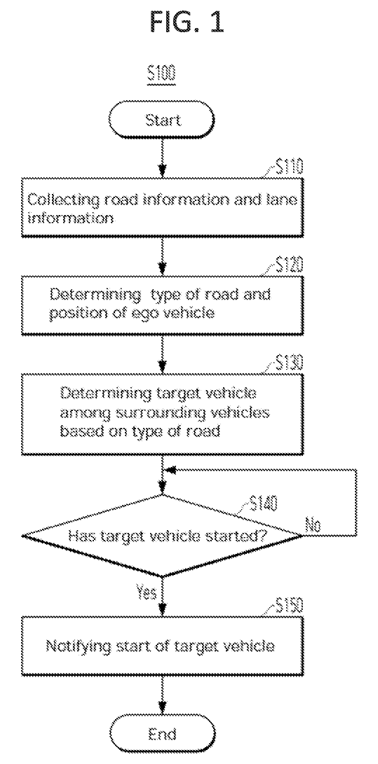

FIG. 1 is a control flowchart showing a method for notifying start of a target vehicle according to an embodiment of the present disclosure.

Referring to FIG. 1, a method of notifying start of a target vehicle S100 according to an embodiment of the present disclosure may comprise collecting road information and lane information of a driving road of an ego vehicle S110 (an information collection step), and determining a type of the driving road of the ego vehicle and a position of the ego vehicle S120.

Specifically, the ego vehicle may be equipped with at least one of a front camera or an SD Map (Standard Definition Map), and the road information of the driving road and lane information where the ego vehicle is located may be may collected by the information collection step S110.

Meanwhile, the front camera may be installed at the windshield of the ego vehicle and may provide image data of the surroundings of the ego vehicle within a predetermined field of view (FOV). From this image data, information about the driving road of the ego vehicle and information about the lane in which the ego vehicle is driving may be provided.

Further, an SD Map (Standard Definition Map) may be a map that represents geographical information as a navigation map. For example, information about the driving road and information about the lane in which the ego vehicle is driving may be provided by a Global Positioning System (GPS) sensor equipped in the ego vehicle and the SD Map.

As described above, from the information collected using at least one of the front camera or the SD Map, the type of the driving road of the ego vehicle and the position of the ego vehicle may be determined (S120).

Subsequently, a target vehicle determination step of determining a target vehicle among surrounding vehicles, based on the type of the driving road of the ego vehicle S130, may be performed.

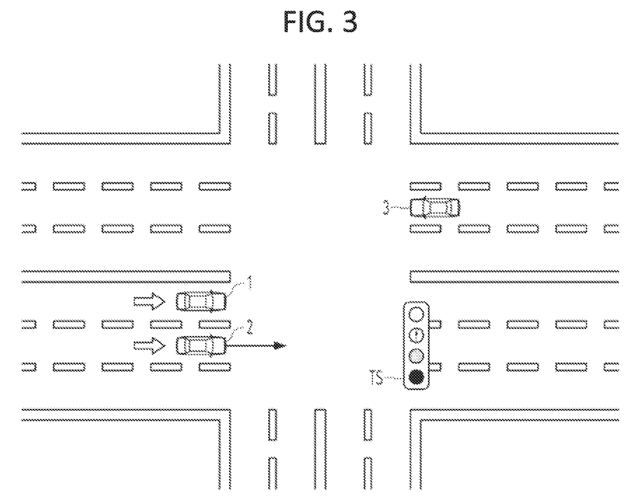

According to the target vehicle determination step S130, for example, the target vehicle may be determined differently based on whether the type of the driving road of the ego vehicle is an intersection, and the specific details of the target vehicle determination step S130 will be explained in more detail through the description of FIGS. 3 to 5 later.

If a target vehicle is determined in the target vehicle determination step S130 based on the type of the driving road of the ego vehicle, then a target vehicle start determination step of determining whether the target vehicle has started S140 may be performed.

If it is determined in the target vehicle start determination step S140 that the target vehicle has started, a start notification step of providing a start notification of the target vehicle to the driver of the ego vehicle in response to determining that the target vehicle has started S150 may be performed.

This start notification may be performed by, for example, at least one of a visual notification or an audible notification. By performing start notification of the target vehicle to the driver of the ego vehicle, it is possible to prevent inconvenience to rear vehicles by having the driver of the ego vehicle start without delay.

According to the embodiment of the present disclosure as described above, in a case where the ego vehicle is stopped as the leading vehicle right before entering an intersection or right before entering a crosswalk on a straight road, by notifying the driver of the ego vehicle who has not recognized the change in the traffic signal of the start of a surrounding target vehicle, it is possible to improve driver convenience and alleviate the traffic congestion.

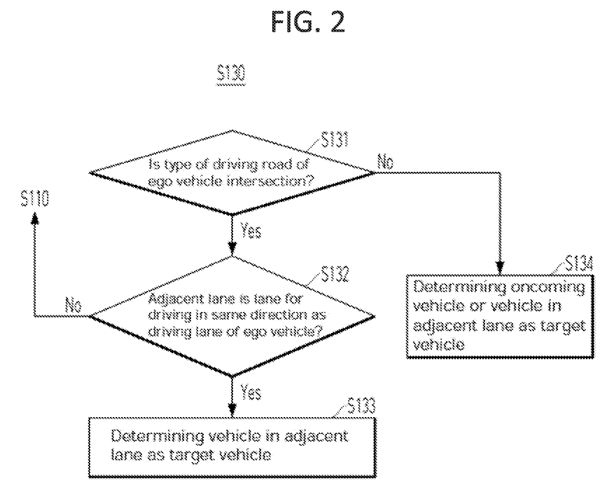

FIG. 2 is a control flowchart more specifically showing a step of determining a target vehicle in the method for notifying start of the target vehicle according to the embodiment of the present disclosure.

Referring to FIG. 2, the target vehicle determination step S130 may include determining whether the driving road of the ego vehicle is an intersection S131. Here, in response to determining that the driving road of the ego vehicle is an intersection, the ego vehicle may be a leading vehicle stopped right before entering the intersection.

If it is determined in step S131 that the driving road of the ego vehicle is an intersection ('Yes' in S131), a lane direction determination step of determining whether the adjacent lane is a lane traveling in the same direction as the driving lane of the ego vehicle S132 may be performed.

In the lane direction determination step S132, if the adjacent lane is a lane traveling in the same direction as the ego vehicle's lane ('Yes' in S132), a surrounding vehicle in the corresponding adjacent lane may be determined as the target vehicle (S133).

For example, in response to determining that the ego vehicle is in a straight lane at an intersection (e.g., a T-intersection, a 4-way intersection, etc.), if the adjacent lane is a straight lane, i.e., if the adjacent lane is a lane for driving in the same direction as the driving lane of ego vehicle, when a surrounding vehicle in the adjacent lane starts (departs), it is a situation where the ego vehicle should also drive in the same direction, so the corresponding surrounding vehicle may be determined as a target vehicle for start notification.

Also, in a case where the ego vehicle is in a left-turn lane at an intersection, if the adjacent lane is also a left-turn lane, the adjacent lane is a lane driving in the same direction as the driving lane of the ego vehicle, so a surrounding vehicle in the adjacent lane may be determined as a target vehicle for start notification. In this regard, whether the adjacent lane is a straight lane or a left-turn lane may be determined from front camera information or SD Map information.

Meanwhile, in response to determining that the driving road of the ego vehicle is an intersection, the driving lane of the ego vehicle is a straight lane, and the adjacent lane of the driving lane of the ego vehicle is a left-turn lane or a right-turn lane, the ego vehicle and the surrounding vehicle in the adjacent lane will be driving in different directions, so even if the surrounding vehicle in the adjacent lane starts (departs), it may be a situation where the ego vehicle should not start (depart). Therefore, in this case, the surrounding vehicle in the adjacent lane needs to be excluded from being determined as the target vehicle.

Or, if the driving road of the ego vehicle is an intersection, and if the driving lane of the ego vehicle is a left-turn lane or a right-turn lane, in case that the adjacent lane is a straight lane, the ego vehicle and the surrounding vehicle in the adjacent lane will be driving in different directions, so even if the surrounding vehicle in the adjacent lane starts, it may be a situation where the ego vehicle should not start. Therefore, in this case, the surrounding vehicle in the adjacent lane needs to be excluded from the target vehicle.

In this regard, whether the driving lane of the ego vehicle and/or the adjacent lane is a straight lane, a right-turn lane, or a left-turn lane may be determined from front camera information or SD Map information.

As described above, if the adjacent lane is a lane driving in a different direction from the driving lane of the ego vehicle ('No' in S132), the surrounding vehicle in the corresponding adjacent lane may be excluded from the target vehicle. In the case where the surrounding vehicle in the adjacent lane is excluded from the target vehicle, the process may return to step S110 to search for another target vehicle.

Meanwhile, if the type of the driving road of the ego vehicle is not an intersection ('No' in S131), an oncoming vehicle or a vehicle in an adjacent lane may be determined as the target vehicle (S134). Here, if the driving road of the ego vehicle is not an intersection, the ego vehicle may be a leading vehicle right before a crosswalk.

If the road on which the ego vehicle is driving is not an intersection (e.g., straight road), there may be no possibility that surrounding vehicles in adjacent lanes will proceed in a different direction from the ego vehicle. Also, in a case of an oncoming surrounding vehicle (a vehicle driving in the opposite direction of the ego vehicle with respect to a crosswalk), it cannot make a left or right turn and can only drive straight in the opposite direction of the ego vehicle, so the oncoming surrounding vehicle may be determined as a target vehicle for start notification.

Also, in a case where the driving road is not an intersection, the oncoming vehicle, that is, the vehicle driving in the opposite direction of the ego vehicle, may have the same traffic signal as the ego vehicle. Therefore, if the oncoming surrounding vehicle is determined as the target vehicle, when the target vehicle has started (started in the straight direction), it may be estimated that the traffic signal of the ego vehicle is a straight signal (a signal allowing straight driving).

In this regard, if the driving road in which the ego vehicle is driving is not an intersection, at least one vehicle of the surrounding vehicle in the adjacent lane and the oncoming surrounding vehicle may be determined as the target vehicle, and a start notification may be provided to the driver of the ego vehicle based on the start of the target vehicle.

FIG. 3 is a diagram showing a driving scenario for explaining a method of determining a target vehicle among surrounding vehicles if the type of the driving road of the ego vehicle is an intersection, in the method for notifying start of the target vehicle according to the embodiment of the present disclosure.

FIG. 3 shows a state where the ego vehicle 1 is stopped in a straight lane at an intersection (a 4-way intersection is shown as an example) according to the sign of the traffic signal TS, if the type of the driving road of the ego vehicle is an intersection, in the method for notifying start of a target vehicle according to the embodiment of the present disclosure.

In this case, according to the embodiment of the present disclosure, because the driving road is an intersection, the oncoming surrounding vehicle 3 of the ego vehicle 1 may not be determined as a target vehicle, whereas the surrounding vehicle 2 in the adjacent lane of the driving lane of the ego vehicle may be determined as a target vehicle.

Meanwhile, according to the embodiment of the present disclosure, it may be determined whether the driving lane of the ego vehicle and the adjacent lane have the same driving direction, and the surrounding vehicle in the adjacent lane may be finally determined as the target vehicle. In the case of FIG. 3, the driving lane of the ego vehicle 1 and the driving lane of the surrounding vehicle 2 in the adjacent lane are straight driving lanes, so the surrounding vehicle 2 in the adjacent lane may be determined as the target vehicle.

Further, when driving the ego vehicle according to the signal of the traffic signal TS, the ego vehicle 1 and the surrounding vehicle 2 would follow the same traffic signal, so when the surrounding vehicle 2 has started, it may be estimated that the surrounding vehicle 2 has started by a straight driving signal, and a start notification of the target vehicle may be provided to the driver of the ego vehicle 1.

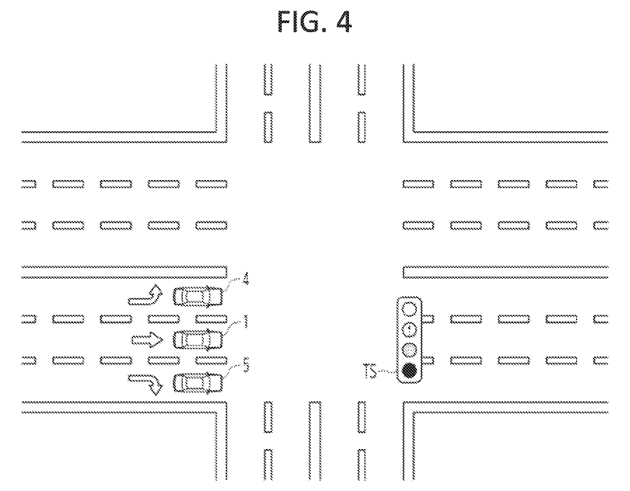

FIG. 4 is a diagram showing a driving scenario for explaining a case of excluding surrounding vehicles from the target vehicle if the type of the driving road of the ego vehicle is an intersection, in the method for notifying start of the target vehicle according to the embodiment of the present disclosure.

FIG. 4 shows a case where, if the type of the driving road of the ego vehicle is an intersection, the driving lane of the ego vehicle 1 is a straight lane, and the adjacent lanes on both sides are a left-turn lane and a right-turn lane, in the method for notifying start of a target vehicle according to the embodiment of the present disclosure.

In this case, among the surrounding vehicles 4, 5 in the adjacent lanes, the surrounding vehicle 4 in the left lane is a vehicle that makes a left turn at the intersection after receiving a left-turn traffic signal, and the surrounding vehicle 5 in the right lane may be a vehicle that makes a right turn at the intersection.

That is, the surrounding vehicles 4, 5 are not vehicles that drive according to the same traffic signal as the ego vehicle 1, so even if the surrounding vehicles 4, 5 start, it may be a situation where the ego vehicle 1 should not start.

Therefore, in the case where the driving road is an intersection, in the driving scenario shown in FIG. 4, there is a need to exclude the surrounding vehicles 4, 5 from the target vehicle, and even if the surrounding vehicles 4, 5 start, a start notification may not be provided to the driver of the ego vehicle 1.

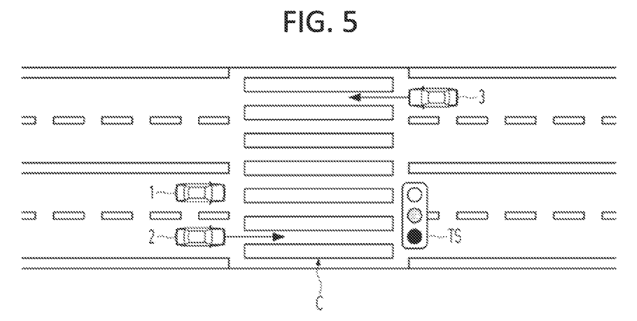

FIG. 5 is a diagram showing a driving scenario for explaining a method of determining a target vehicle among surrounding vehicles if the type of the driving road of the ego vehicle is not an intersection, in the method for notifying start of the target vehicle according to the embodiment of the present disclosure.

FIG. 5 shows a case where the type of the driving road of the ego vehicle 1 is a straight road. Meanwhile, the embodiment of FIG. 5 exemplifies the case of a straight road, but it is not limited thereto, and may be a road of another type such as a curved road as long as it is not an intersection.

Referring to FIG. 5, when the ego vehicle 1 is located at the front right before a crosswalk C according to the stop sign of the traffic signal TS, the surrounding vehicle 2 in the adjacent lane of the ego vehicle's lane and the oncoming surrounding vehicle 3 may be stopped according to the stop sign of the traffic signal TS.

Meanwhile, according to the embodiment of the present disclosure, since the type of the driving road of the ego vehicle 1 is not an intersection, either one of the oncoming surrounding vehicle 3 and the surrounding vehicle 2 in the adjacent lane may be the target vehicle.

Accordingly, when starting according to the traffic sign of the traffic signal TS, the ego vehicle 1 and the surrounding vehicles 2, 3 will follow the same traffic signal, so when any one of the surrounding vehicles 2, 3 has started, it may be estimated that it has started after receiving a straight driving signal (i.e., after the straight driving signal is on), and a start notification of the target vehicle may be provided to the driver of the ego vehicle 1.

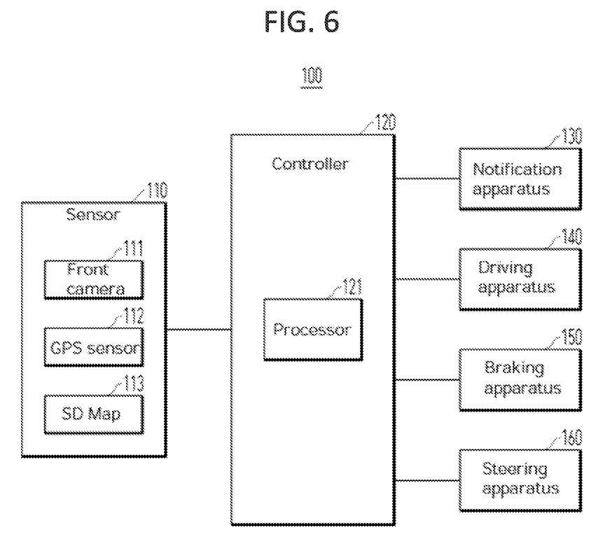

FIG. 6 is a control configuration diagram schematically showing the configuration of a system for notifying start of a target vehicle according to embodiments of the present disclosure.

Referring to FIG. 6, a system for notifying start of a target vehicle 100 according to embodiments of the present disclosure may comprise: a sensor 110 configured to provide road information and lane information of a driving road of an ego vehicle; and a controller 120 comprising at least one processor 121 configured to determine a type of the driving road of the ego vehicle and a position of the ego vehicle based on information from the sensor 110, and control the ego vehicle.

The controller 120 may determine a target vehicle among surrounding vehicles according to whether the type of the driving road of the ego vehicle is an intersection, determine whether the target vehicle has started, and notify start of the target vehicle to a driver of the ego vehicle in response to determining that the target vehicle has started.

The sensor 110 may comprise at least one of a front camera 111 or an Standard Definition (SD) Map 113 installed at the ego vehicle. Also, the sensor 110 may further comprise a Global Positioning System (GPS) sensor 112 for sensing the position of the ego vehicle.

Meanwhile, the sensors included in the sensor 110 are not limited to the above, and may further include other types of sensors for sensing the surroundings of the ego vehicle, such as a radar sensor, a lidar sensor, an ultrasonic sensor, etc., and may further include body information sensors for sensing body information of the ego vehicle, such as a speed sensor, a steering angle sensor, etc.

Further, in response to determining that the driving road of the ego vehicle is an intersection, the controller 120 may determine a surrounding vehicle in an adjacent lane of the driving lane of the ego vehicle as the target vehicle.

Further, in response to determining that the driving road of the ego vehicle is an intersection, the driving lane of the ego vehicle is a straight lane, and an adjacent lane of the driving lane of the ego vehicle is a left-turn lane or a right-turn lane, the controller 120 may exclude a surrounding vehicle in the adjacent lane from being determined as the target vehicle.

Further, in response to determining that the driving road of the ego vehicle is an intersection, the driving lane of the ego vehicle is a left-turn lane or a right-turn lane, and an adjacent lane of the driving lane of the ego vehicle is a straight lane, the controller 120 may exclude a surrounding vehicle in the adjacent lane from being determined as the target vehicle.

Further, in response to determining that the driving road of the ego vehicle is not an intersection, the controller 120 may determine at least one of (i) an oncoming surrounding vehicle or (ii) a surrounding vehicle in the adjacent lane as the target vehicle.

Further, in response to determining that the driving road of the ego vehicle is not an intersection, and if the oncoming surrounding vehicle is the target vehicle, when the target vehicle has started, the controller 120 may estimate that the traffic signal of the ego vehicle is a straight driving signal. Accordingly, when the target vehicle has started, a start notification may be provided to the driver of the ego vehicle.

Further, the controller 120 may be connected to a notification apparatus 130 configured to notify the start of the target vehicle to the driver of the ego vehicle. The notification apparatus 130 may comprise at least one of a visual notification device or an audible notification device.

The controller 120 may control the notification apparatus 130 to provide at least one of a visual notification or an audible notification to the driver of the ego vehicle in response to determining that the target vehicle determined by target vehicle determination has started.

Further, the controller 120 may be connected to a driving apparatus 140 (e.g., an engine and/or an electric motor, or the like) configured to control longitudinal driving of the ego vehicle, a braking apparatus 150 (e.g., a braking system with one or more of friction brakes, regenerative brakes, or the like) configured to control braking of the ego vehicle, and a steering apparatus 160 (e.g., a steering system with one or more of gear, racks, pinions, a steering assist motor, or the like) configured to control lateral driving of the ego vehicle. The controller 120 may control at least one of the driving apparatus 140, the braking apparatus 150, or the steering apparatus 160 as needed, to perform a driver assistance function. In one or more embodiments, in response to detecting that a target vehicle has started, the controller 120 is configured to, in addition to notifying the driver as described herein, automatically control a travel of the ego vehicle, e.g., by controlling at least one of the driving apparatus 140, the braking apparatus 150, or the steering apparatus 160 to automatically start the ego vehicle or to automatically start moving the ego vehicle from a stopped state.

Regarding the method for notifying start of a target vehicle according to the embodiment of the present disclosure performed by the controller 120, since it has been described in detail previously, a detailed description thereof will be omitted here.

The disclosed embodiments may also be implemented as a computer-readable program on a computer-readable recording medium in order to be executed by a computer. A computer-readable recording medium may be a non-transitory computer-readable recording medium, such as a data storage device capable of storing data that may be read by a processor/microprocessor.

Examples of computer-readable recording media may include hard disk drives (HDD), solid-state drives (SSD), silicon disk drives (SDD), read-only memory (ROM), CD-ROM, magnetic tape, floppy disks, optical data storage devices, etc.

According to the embodiments of the present disclosure as described above, when the traffic signal changes to a drivable signal, by enabling the driver of the ego vehicle to start quickly, it is possible to provide a method and system for notifying start of a target vehicle that can resolve inconvenience to rear vehicles and also alleviate traffic congestion.

Further, according to the embodiments of the present disclosure, by determining the target vehicle differently when the driving road of the ego vehicle is an intersection and when it is not an intersection, it is possible to provide a method and system for notifying start of a target vehicle that can effectively determine the target vehicle which is the basis for the start notification.

Furthermore, according to the method and system for notifying start of a target vehicle according to the embodiments of the present disclosure, by utilizing the existing system without additional hardware or sensors to provide start notification, a significant effect of reducing the design cost of the start notification system can also be achieved.

The above description of the present disclosure is for illustrative purposes, and those skilled in the art may understand that it can be easily modified into other specific forms without changing the technical spirit or essential features of the present disclosure. Therefore, the embodiments described above should be understood as illustrative in all respects and not limiting. For example, each component described as a single type may be implemented in a distributed manner, and similarly, components described as distributed may be implemented in a combined form.

The scope of the present disclosure is indicated by the following claims rather than the above detailed description, and all changes or modifications derived from the meaning and scope of the claims and equivalent concepts should be interpreted to be included in the scope of the present disclosure.

What is claimed is:

1. A method of notifying start of a target vehicle, the method comprising:
collecting road information and lane information of a driving road of an ego vehicle;
determining a type of the driving road of the ego vehicle and a position of the ego vehicle;
determining a target vehicle among surrounding vehicles, based on the type of the driving road of the ego vehicle;
determining whether the target vehicle has started; and
notifying start of the target vehicle to a driver of the ego vehicle in response to determining that the target vehicle has started.

2. The method of claim 1, wherein the collecting of the road information and the lane information comprises collecting information from at least one of a front camera or a Standard Definition (SD) Map on the ego vehicle.

3. The method of claim 1, wherein, in the determining of the target vehicle,
in response to determining that the driving road of the ego vehicle is an intersection,
a surrounding vehicle in an adjacent lane of a driving lane of the ego vehicle is determined as the target vehicle.

4. The method of claim 1, wherein, in the determining of the target vehicle,
in response to determining that the driving road of the ego vehicle is an intersection, and the ego vehicle is a leading vehicle stopped right before entering the intersection,
a surrounding vehicle in an adjacent lane of a driving lane of the ego vehicle is determined as the target vehicle.

5. The method of claim 1, wherein, in the determining of the target vehicle,
in response to determining that the driving road of the ego vehicle is an intersection, a driving lane of the ego vehicle is a straight lane, and an adjacent lane of the driving lane of the ego vehicle is a left-turn lane or a right-turn lane,
a surrounding vehicle in the adjacent lane is excluded from being determined as the target vehicle.

6. The method of claim 1, wherein, in the determining of the target vehicle,
in response to determining that the driving road of the ego vehicle is an intersection, a driving lane of the ego vehicle is a left-turn lane or a right-turn lane, and an adjacent lane of the driving lane of the ego vehicle is a straight lane,
a surrounding vehicle in the adjacent lane is excluded from being determined as the target vehicle.

7. The method of claim 1, wherein, in the determining of the target vehicle,
in response to determining that the driving road of the ego vehicle is not an intersection,
at least one vehicle of (i) an oncoming surrounding vehicle or (ii) a surrounding vehicle in an adjacent lane of a driving lane of the ego vehicle is determined as the target vehicle.

8. The method of claim 1, wherein, in the determining of the target vehicle,
in response to determining that the driving road of the ego vehicle is not an intersection, and the ego vehicle is a leading vehicle stopped right before a crosswalk,
at least one vehicle of (i) an oncoming surrounding vehicle or (ii) a surrounding vehicle in an adjacent lane of a driving lane of the ego vehicle is determined as the target vehicle.

9. The method of claim 8, further comprising:
in response to determining that the oncoming surrounding vehicle is the target vehicle, and the target vehicle has started,
estimating that a traffic signal of the ego vehicle is a straight driving signal.

10. The method of claim 1, wherein the notifying of the start of the target vehicle comprises providing at least one of a visual notification or an audible notification to the driver of the ego vehicle.

11. A system for notifying start of a target vehicle, the system comprising:
a sensor configured to provide road information and lane information of a driving road of an ego vehicle; and
a controller comprising at least one processor configured to determine a type of the driving road of the ego vehicle and a position of the ego vehicle based on information from the sensor, and control the ego vehicle,
wherein the controller is further configured to
determine a target vehicle among surrounding vehicles based on the type of the driving road of the ego vehicle,
determine whether the target vehicle has started, and
notify start of the target vehicle to a driver of the ego vehicle in response to determining that the target vehicle has started.

12. The system of claim 11, wherein the sensor comprises at least one of a front camera or a Standard Definition (SD) Map on the ego vehicle.

13. The system of claim 11, wherein the sensor further comprises a Global Positioning System (GPS) sensor.

14. The system of claim 11, wherein
in response to determining that the driving road of the ego vehicle is an intersection,
the controller is configured to determine a surrounding vehicle in an adjacent lane of a driving lane of the ego vehicle as the target vehicle.

15. The system of claim 11, wherein
in response to determining that the driving road of the ego vehicle is an intersection, a driving lane of the ego vehicle is a straight lane, and an adjacent lane of the driving lane of the ego vehicle is a left-turn lane or a right-turn lane,
the controller is configured to exclude a surrounding vehicle in the adjacent lane from being determined as the target vehicle.

16. The system of claim 11, wherein
in response to determining that the driving road of the ego vehicle is an intersection, a driving lane of the ego vehicle is a left-turn lane or a right-turn lane, and an adjacent lane of the driving lane of the ego vehicle is a straight lane,
the controller is configured to exclude a surrounding vehicle in the adjacent lane from being determined as the target vehicle.

17. The system of claim 11, wherein
in response to determining that the driving road of the ego vehicle is not an intersection,
the controller is configured to determine at least one of (i) an oncoming surrounding vehicle or (ii) a surrounding vehicle in an adjacent lane of a driving lane of the ego vehicle as the target vehicle.

18. The system of claim 17, wherein
in response to determining that the oncoming surrounding vehicle is the target vehicle, and the target vehicle has started,
the controller is configured to estimate that a traffic signal of the ego vehicle is a straight driving signal.

19. The system of claim 11, further comprising:
a notification apparatus configured to notify the start of the target vehicle to the driver of the ego vehicle,
wherein the controller is connected to the notification apparatus and configured to control the notification apparatus to provide at least one of a visual notification or an audible notification to the driver of the ego vehicle in response to determining that the target vehicle has started.

20. A non-transitory computer-readable recording medium that records therein a program executable by a computer to cause the computer to execute a method of notifying start of a target vehicle, the method comprising:
collecting road information and lane information of a driving road of an ego vehicle;
determining a type of the driving road of the ego vehicle and a position of the ego vehicle;
determining a target vehicle among surrounding vehicles, based on the type of the driving road of the ego vehicle;
determining whether the target vehicle has started; and
notifying start of the target vehicle to a driver of the ego vehicle in response to determining that the target vehicle has started.
